(19) United States
(12) Patent Application Publication
(10) Pub. No.: US 2025/0227522 A1
(43) Pub. Date: Jul. 10, 2025

(54) Method and Apparatus for Supporting QoE Measurements

(71) Applicant: Telefonaktiebolaget LM Ericsson (publ), Stockholm (SE)

(72) Inventors: Johan Rune, Lidingõ (SE); Luca Lunardi, Genoa (IT); Cecillia Eklöf, Tãby (SE); Filip Barac, Huddinge (SE)

(21) Appl. No.: 18/701,842

(22) PCT Filed: Sep. 30, 2022
(86) PCT No.: PCT/SE2022/050875

§ 371 Date: Apr. 16, 2024

Related U.S. Application Data
(60) Provisional application No. 63/270,223, filed on Oct. 21, 2021.

(51) Int. Cl. H04W 24/08; H04W 24/10; H04W 48/18

(52) U.S. Cl. CPC H04W 24/08; H04W 24/10; H04W 48/18

(57) ABSTRACT

A method performed by a user equipment for supporting Quality of Experience (QoE) measurements. The method comprises determining whether a QoE measurement configuration is to be applied to an application session based on an identifier relating to an application running the application session.

### TECHNICAL FIELD

Embodiments of the present disclosure relate to methods, User Equipments (UEs) and base stations, and particularly methods, UEs and base stations for supporting Quality of Experience (QoE) measurements.

### BACKGROUND

QoE measurements have been specified for LTE and UMTS and are being specified for NR. The purpose of the application layer measurements is to measure the end user experience when using certain applications. Currently QoE measurements for streaming services and for MTSI (Mobility Telephony Service for IMS) services are supported.

The solutions in LTE and UMTS are similar with the overall principles as follows. Quality of Experience Measurement Collection enables configuration of application layer measurements in the UE and transmission of QoE measurement result files by means of RRC signaling. Application layer measurement configuration received from O&M or CN is encapsulated in a transparent container, which is forwarded to UE in a downlink RRC message. Application layer measurements received from UE's higher layer are encapsulated in a transparent container and sent to network in an uplink RRC message. The result container is forwarded to a TCE, Trace Collector Entity.

In 3GPP release 17 a study item for “Study on NR QoE management and optimizations for diverse services” for NR has been carried out. The purpose of the study item was to study solutions for QoE measurements in NR. QoE management in NR will not just collect the experience parameters of streaming services but also considers the typical performance requirements of diverse services (e.g. AR/VR and URLLC).

The measurements may be initiated towards RAN in a management-based manner, i.e. from an O&M node in a generic way e.g. for a group of UEs, which may be selected by the RAN, or they may also be initiated in a signaling-based manner, i.e. initiated from CN (on request from the O&M system) to RAN e.g. for a single specific UE. The configuration of the measurement includes the measurement details, which is encapsulated in a container that is transparent to RAN.

When initiated via the core network, the measurement is started towards a specific UE. For the LTE case, the “TRACE START” S1AP message is used, which carries, among others, the details about the measurement configuration the application should collect (in the “Container for application layer measurement configuration” IE, transparent to the RAN) and the details to reach the trace collection entity to which the measurements should be sent.

Notifications of started and stopped application sessions with associated QoE measurement configurations are introduced, where these notifications are conveyed from the application layer in the UE and to the UE Access Stratum (i.e. the radio layers in the UE) and then forwarded to the network. This allows the network (at least the RAN) to be aware of when QoE measurements on an application session are ongoing. It is an implementation decision when the RAN stops the measurements. Typically, it is done when the UE has moved outside the configured area for measurement (also referred to as the area scope). However, this strategy is questioned by the desire to have QoE data that represent complete application sessions.

The signaling diagram in FIG. 1 is copied from 3GPP TS 28.405 v16.0.0. It provides an overview (without showing all the details) of the signaling involved in QoE measurement configuration, from the O&M system to the UE.

FIG. 1 is a signaling diagram illustrating the basic signaling (without showing all details) involved in QoE measurement configuration, from the O&M system to the UE. The diagram is a copy of a diagram in 3GPP TS 28.405 v16.0.0 labeled “FIG. 4.2.1-1: QMC activation and reporting in LTE”.

One opportunity provided by the legacy solution is also to be able to keep the QoE measurement for the whole application session, even during handover situation, so that reported QoE measurement data cover complete application sessions.

### E-UTRAN—Application Layer Measurement Capabilities

For E-UTRAN, the UE capability transfer is used to transfer UE radio access capability information from the UE to E-UTRAN.

FIG. 2 is a signalling diagram showing UE capability transfer—E-UTRAN

The UE-EUTRA-Capability IE is used to convey the E-UTRA UE Radio Access Capability Parameters and the Feature Group Indicators for mandatory features to the network.

In the response message “UECapabilityInformation”, the UE can include the “UE-EUTRA-Capability” IE. The “UE-EUTRA-Capability” IE may include the UE-EUTRA-Capability-v1530 IE which can be used by the UE to indicate whether the UE supports or not QoE Measurement Collection for streaming services and/or MTSI services, as detailed in the “MeasParameters-v1530” IE encoding below.

The contribution CR 4297 (R2-2004624) for 3GPP TS 36.331 v16.0.0 at the 3GPP TSG RAN2 Meeting #110 proposed an extension of the “UE-EUTRA-Capability” IE that, within the “UE-EUTRA-Capability-vl6xy IE may include a “measParameters-vl6xy” IE comprising the qoe-Extensions-r16 IE. The qoe-Extensions-r16 IE may be used to indicate whether the UE supports the release 16 extensions for QoE Measurement Collection, i.e. if the UE supports more than one QoE measurement type at a time and if the UE supports the signaling of withinArea, sessionRecordingIndication, qoe-Reference, temporaryStopQoE and restartQoE.

### E-UTRAN—Application Layer Measurement Reporting

The purpose of the “Application layer measurement reporting” procedure described in 3GPP TS 36.331 and shown below is to inform E-UTRAN about the application layer measurement report.

FIG. 3 is a signalling diagram showing application layer measurement reporting in E-UTRAN

A UE capable of application layer measurement reporting in RRC_CONNECTED may initiate the procedure when configured with application layer measurement, i.e. when measConfigAppLayer has been configured by E-UTRAN.

Upon initiating the procedure, the UE shall:
1> if configured with application layer measurement, and SRB4 is configured, and the UE has received application layer measurement report information from upper layers:
2> set the measReportAppLayerContainer in the MeasReportAppLayer message to the value of the application layer measurement report information;
2> set the serviceType in the MeasReportAppLayer message to the type of the application layer measurement report information;
2> submit the MeasReportAppLayer message to lower layers for transmission via SRB4.

### E-UTRAN—QoE Measurement Configuration Setup and Release—RRC Signaling

The RRCConnectionReconfiguration message is used to reconfigure the UE to setup or release the UE for Application Layer measurements. This is signaled in the measConfigAppLayer-15 IE within the “OtherConfig” IE.

The setup includes the transparent container measConfigAppLayerContainer which specifies the QoE measurement configuration for the Application of interest and the serviceType IE to indicate the Application (or service) for which the QoE measurements are being configured. Supported services are streaming and MTSI.

The contribution CR 4297 (R2-2004624) for 3GPP TS 36.331 v16.0.0 at the 3GPP TSG RAN2 Meeting #110 proposed to extend the QoE measurement configuration.

The measConfigAppLayerToAddModList-r16 may be used to add or modify multiple QoE measurement configurations (up to maxQoE-Measurement-r16). The measConfigAppLayerToReleaseList-r16 IE may be used to remove multiple QoE measurement configuration (up to maxQoE-Measurement-r16).

### E-UTRAN—QoE Measurement Reporting—RRC Signaling

As specified in 3GPP TS 36.331, the MeasReportAppLayer RRC message is used by the UE to send to the E-UTRAN node the QoE measurement results of an Application (or service). The service for which the report is being sent is indicated in the “serviceType” IE.

The contribution CR 4297 (R2-2004624) for 3GPP TS 36.331 v16.0.0 at the 3GPP TSG RAN2 Meeting #110 proposed to extend the MeasReportAppLayer IEs introducing a QoE reference comprising the PLMN identity and the identifier of the QoE Measurement Collection

For E-UTRAN, an example of desired UE behavior for Application layer measurement reporting is described in CR 4297 (R2-2004624):

The “UE Application layer measurement configuration” IE is described in 3GPP TS 36.413 v16.3.0 and TS 36.423 v16.3.0.

According to 3GPP TS 28.405, the area scope parameter defines the area in terms of cells or Tracking Area/Routing Area/Location Area where the QMC shall take place. If the parameter is not present the QMC shall be done throughout the PLMN specified in PLMN target.

The area scope parameter in UMTS is either:
List of cells, identified by CGI. Maximum 32 CGI can be defined.
List of Routing Area, identified by RAI. Maximum of 8 RAIs can be defined.
List of Location Area, identified by LAI. Maximum of 8 LAIs can be defined.

The area scope parameter in LTE is either:
list of cells, identified by E-UTRAN-CGI. Maximum 32 CGI can be defined.
List of Tracking Area, identified by TAC. Maximum of 8 TAC can be defined.

The parameter is mandatory if area based QMC is requested.

At the RAN3 #112-e meeting, the following was agreed:

Introduce the following additional new IEs:
a list of UE Application layer measurement configuration IE for each service type

RAN2 also sent a liaison (LS) to RAN3 (RAN2 Tdoc number: R2-2106776, RAN3 Tdoc number: R3-213124), where the following, which was one of the questions in the LS, was related to multiple QoE measurement configurations for the same service type:
Issue 2: Provide multiple QoE measurement configurations for one certain service type
RAN2 is discussing QoE configuration and reporting signalling support, and some companies mention it is possible that multiple QoE measurement configurations can be provided to UE for one certain service type, e.g. different QoE measurement configurations for different slices may be applied to one service type, or different QoE measurement configurations may be applied for different application providers. RAN2 would like to check with SA5/RAN3 whether it is possible to provide multiple QoE measurement configurations for one certain service type?

At the RAN3 #113-e meeting, RAN3 provided the following response to the above in a reply LS with RAN3 Tdoc number R3-214471:
Answer: From RAN3 perspective, it is possible to provide multiple QoE measurement configurations for one certain service type. But it's up to RAN2 and SA5 to make the final confirmation.
Regarding the slice example in Issue 2, the condition is dependent on whether QoE measurement is configured per service type, and whether different slices for the same service type are provided with the same QMC configuration container. RAN3 can confirm that QoE measurement configurations are configured per service type, but RAN3 is unable to confirm that different slices for the same service type will be provided with the same container, so further confirmation from SA4 is needed.
Regarding the application provider example in Issue 2, from RAN3 perspective, each QoE measurement configuration is associated with a unique QoE Reference and only one QMC MCE address. And RAN3 assumes it is possible that different slices for the same service type are configured with different QMC MCE addresses, which is to be confirmed with SA5. So in this case, multiple QoE measurement configurations may be provided for a certain service type.

It has also been proposed to introduce service subtypes to enable multiple QoE measurement configurations per service type, where a service type is assumed to have a rather wide scope (e.g. an umbrella term), covering multiple related, but mutually different applications, where these applications are denoted service subtypes. It is further assumed that the service type-service subtype classification is based on relations which result in that there a are a set of QoE metrics that are relevant for all the applications within the service type and in addition each application may have a set of relevant QoE metrics which it does not have in common with all the other applications with the same service type.

There currently exist certain challenge(s). Multiple applications (possibly from different application providers) pertaining to the same service type (e.g., streaming) may run at the same UE, or at different UEs in the same network. 3GPP is considering enabling, per UE, multiple QoE measurement configurations for the same service type, e.g. different QoE measurement configurations for different network slices (which is the only distinguisher/filter criterion for QoE configurations for the same service type agreed in 3GPP so far) for the same service type or for different application vendors implementing the same service type. When a list of network slice(s) is(are) configured with QoE measurements for this purpose, the network slice(s) are used to carry the application data, and whether it/they match(es) the one(s) associated with the QoE configuration, determines whether QoE measurements, in accordance with the QoE configuration, are activated when an application session of the concerned service type starts. For example, a QoE measurement configuration is activated only if one or more of the network slice(s) indicated therein are used for delivering the service. This means that, if multiple QoE measurement configurations for the same service type are configured at a UE, they can be distinguished based on the network slice(s) indicated in their respective QoE measurement configurations. However, there are no concrete solutions for how to enable this distinction between QoE measurement configurations for the same service type. Moreover, it should be noted that the use of network slicing (both in general and as a filtering criterion) is optional.

Earlier proposals involve a different approach to enable distinction between multiple QoE measurement configurations per service type by introducing the concept of service subtypes, where service subtypes represent specific applications (or application types) which are related and fit under the wider scope assumed for a service type (which is supposed to cover multiple service subtypes). However, this requires new classification/standardization of service subtypes and in addition does not enable distinguishing of different implementations (e.g. by different application vendors) of the same application (or application type). In other words, QoE measurement configuration pertaining exclusively to a specific application from a specific application provider (and not pertaining to other applications for the same service type, provided by other application providers), is not supported as of today.

### SUMMARY

It is an object of the present disclosure to provide methods and apparatus for supporting more fine granular QoE measurements, thereby allowing more specific information to be obtained.

An embodiment of the disclosure provides a method performed by a user equipment for supporting QoE measurements. The method comprises determining whether a QoE measurement configuration is to be applied to an application session based on an identifier relating to an application running the application session.

A further embodiment of the disclosure provides a method performed by a network node for supporting QoE measurements. The method comprises sending, to a UE and/or another network node, an identifier for determining whether a QoE measurement configuration is to be applied to an application session based on the identifier relating to an application running the application session.

Further embodiments provide UEs, network nodes and communication systems comprising one or more of UEs and network nodes configured to perform methods in accordance with embodiments.

Certain aspects of the disclosure and their embodiments may provide solutions to these or other challenges. To address the above-described problem, the proposed solution leverages the existing association between each app/application distributed e.g. via App Store (Apple's store for iOS apps) or Google Play (Google's store for Android apps) and an identifier which uniquely identifies the app/application. Such an identifier can be used as distinguisher, or filter criterion, determining whether a certain QoE measurement configuration should be applied to a started application session. This identifier may be combined with the service type, so that QoE measurements in accordance with a certain QoE measurement configuration are performed on an application session only if all the distinguishers/filter criteria associated with the QoE measurement configuration (i.e. service type and app/application identifier) match those associated with the application running the session. This mechanism thus enables multiple QoE measurement configurations for the same service type (in the same UE), where the application's associated identifier (e.g. app identifier or application identifier) determines which (if any) of the QoE measurement configurations associated with the application's service type that should be applied to a session of the application.

The core essence of the solution is to use identifiers associated with applications/application implementations (such as App Store and Google Play app/application identifiers) as distinguisher(s)/filter criterion/criteria determining which application session(s) a certain QoE measurement configuration should be applied to. The application identifier(s) may be combined with the Service Type distinguisher, thereby enabling multiple QoE measurement configurations for the same Service Type, wherein the application identifier(s) associated with each QoE measurement configuration determines to which application session(s) the QoE measurement configuration should be applied.

Certain embodiments may provide one or more of the following technical advantage(s). The proposed solution enables configuration of different QoE measurement configurations for different apps/applications, representing different implementations (e.g. from different vendors) of the same service type. This allows targeting specific implementations of a certain service type, as well as measuring in different ways (e.g. in terms of metrics or in terms of intensity) for the same service type, depending on the actual application instance (e.g. a certain app implementation). This allows the network/operator to perform more fine-granular analysis of QoE related information, e.g. to determine if QoE related problems are more associated with certain application implementations than with others. Furthermore, one can envision that an application provider has a service level agreement (SLA) with a network operator, and then selective QoE measurements on that particular application (as identified by the application identifier) could be used in the verification of whether the SLA is fulfilled.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a signaling diagram illustrating the basic signaling involved in QoE measurement configuration, from the O&M system to the UE;

FIG. 2 illustrates UE capability transfer—E-UTRAN;

FIG. 3 illustrates Application layer measurement reporting in E-UTRAN;

FIG. 4A illustrates a method in accordance with some embodiments;

FIG. 4B illustrates a method in accordance with some embodiments;

FIG. 5 illustrates an example of how application identifier(s) can be incorporated in the signaling involved in QoE measurement configuration and QoE measurement reporting;

FIG. 6 illustrates an example of how application identifier(s) can be incorporated in the signaling involved in QoE measurement configuration and QoE measurement reporting;

FIG. 7 illustrates an example of how application identifier(s) can be incorporated in the signaling involved in QoE measurement configuration and QoE measurement reporting;

FIG. 8 illustrates an example of how application identifier(s) can be incorporated in the signaling involved in QoE measurement configuration and QoE measurement reporting;

FIG. 9 illustrates an example of how application identifier(s) can be incorporated in the signaling involved in QoE measurement configuration and QoE measurement reporting;

FIG. 10 illustrates an example of how application identifier(s) can be incorporated in the signaling involved in QoE measurement configuration and QoE measurement reporting;

FIG. 11 illustrates an example of how application identifier(s) can be incorporated in the signaling involved in QoE measurement configuration and QoE measurement reporting;

FIG. 12 illustrates an example of how application identifier(s) can be incorporated in the signaling involved in QoE measurement configuration and QoE measurement reporting;

FIG. 13 shows an example of a communication system in accordance with some embodiments;

FIG. 14 shows an example of a UE in accordance with some embodiments;

FIG. 15 shows an example of a network node in accordance with some embodiments; and

FIG. 16 is a block diagram of a host in accordance with some embodiments;

FIG. 17 is a block diagram illustrating a virtualization environment in which functions implemented by some embodiments may be virtualized; and

FIG. 18 shows an example of a communication diagram of a host communicating via a network node with a UE over a partially wireless connection in accordance with some embodiments.

### ADDITIONAL EXPLANATION

Some of the embodiments contemplated herein will now be described more fully with reference to the accompanying drawings. Embodiments are provided by way of example to convey the scope of the subject matter to those skilled in the art.

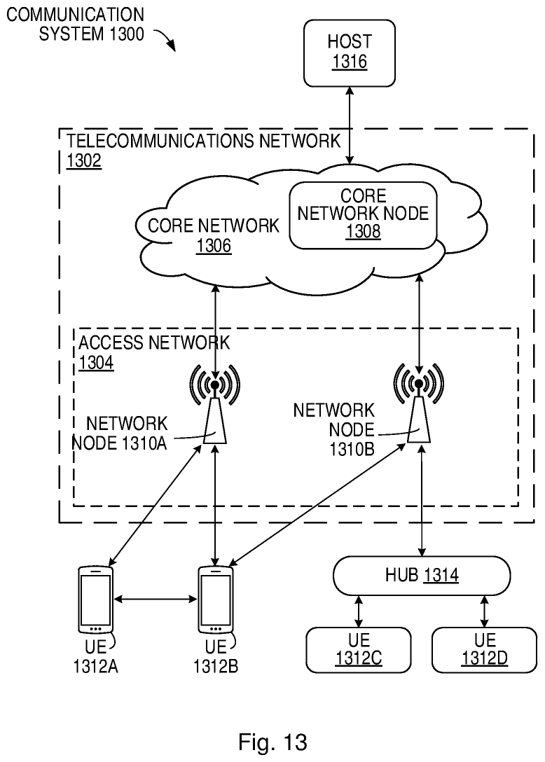

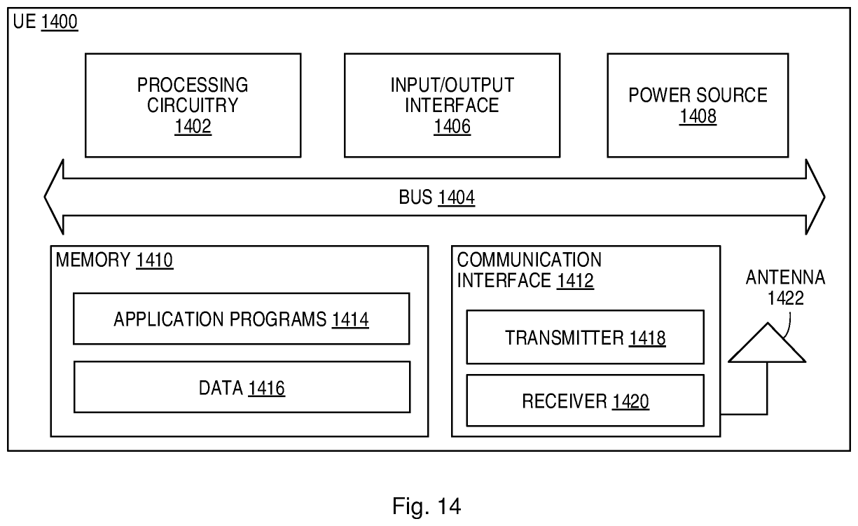

FIG. 4A depicts a method in accordance with particular embodiments. The method 4A may be performed by a UE or wireless device (e.g. the UE 1312 or UE 1400 as described later with reference to FIGS. 13 and 14 respectively). The method begins at step 4A02 with a step of determining whether a QoE measurement configuration is to be applied to an application session based on an identifier relating to an application running the application session.

The determining may be based on a service type. The determining may be further based on Single Network Slice Selection Assistance Information, S-NSSAI. At least one of the identifier, a service type, and an S-NSSAI may be usable as a distinguisher and/or a filter criterion to determine whether a QoE measurement configuration is to be applied to the application session. At least one QoE measurement corresponding to the QoE measurement configuration may be applied to the application session if a distinguisher and/or a filter criterion associated with the QoE measurement configuration match a distinguisher and/or a filter criterion corresponding to at least one of the identifier, a service type and S-NSSAI. The method may further comprise, if it is determined that a QoE measurement configuration should be applied to an application session, performing at least one QoE measurement corresponding to the QoE measurement configuration. The method may further comprise sending a QoE report of the at least one QoE measurement to a network node. The identifier may relate to at least one of: the application, a version of the application, an application implementation.

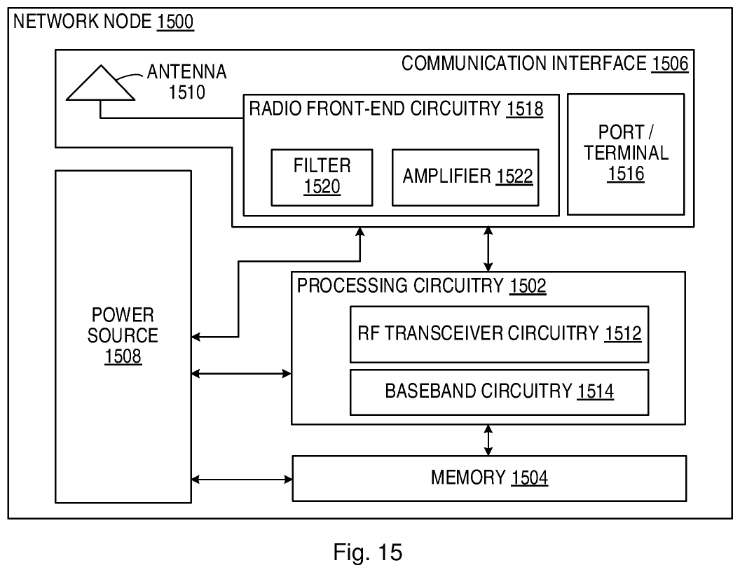

FIG. 4B depicts a method in accordance with particular embodiments. The method 4B may be performed by a network node (e.g. the network node 1310 or network node 1500 as described later with reference to FIGS. 13 and 15 respectively). The method begins at step 4B02 with a step of sending, to a UE and/or another network node, an identifier for determining whether a QoE measurement configuration is to be applied to an application session based on the identifier relating to an application running the application session.

The method may further comprise receiving a QoE report of at least one QoE measurement. The QoE report may further comprises at least one of: the identifier, an application identifier, an application version identifier, an indication of the application user subscription level. The method may further comprise receiving at least two QoE measurements corresponding to two identifiers, and comparing the at least two QoE measurements. The comparison may further comprise determining correlation of inputs relating to at least one of: radio related measurements, radio related information, timestamps, geographical data associated with the UE, and wherein the inputs are collected in a time period during which the corresponding application session is running and a QoE measurement is performed. The method may further comprise receiving an indication of an identifier relating to an application installed at the UE. The method may further comprise requesting the indication. The method may comprise sending a user subscription level.

The terms “legacy QoE metrics” and “regular QoE metrics” refer to the application layer measurements for different services defined in 3GPP SA4 specifications (e.g. TS 26.247 for 3GP-DASH streaming service and progressive download, or TS 26.118 for VR profiles for streaming applications), which are delivered from the UE to a network entity via RAN, where RAN is unable to read the QoE reports containing the measured values of these metrics. Similarly, the terms “legacy QoE configuration”, “regular QoE configuration”, “legacy QoE measurement configuration” and “regular QoE measurement configuration” refer to the configuration information in a QMC configuration XML file, which the RAN receives from the O&M system or the core network and forwards it to one or more UE (and wherein the RAN cannot interpret the content of the legacy/regular QoE configuration).

The term “RAN Visible QoE” and the corresponding abbreviations “RV-QOE”, “RVQoE” or “rvgoe” are used interchangeably.

When used herein, the term “RAN Visible QoE” may comprise RAN Visible QoE measurement, RAN Visible QoE measurement reporting, RAN Visible QoE parameters and metrics, processing of information to derive RAN Visible QoE parameters/metrics/information/data, and the term “RAN Visible QoE” may also be used to refer to the overall framework for RAN Visible QoE.

The terms “QoE measurement report”, “QoE report”, “measurement report” and “report” are used interchangeably.

The terms “QoE measurement configuration”, “QoE measurement and reporting configuration”, “QoE measurement”, “QoE configuration” and “application layer measurement configuration” are used interchangeably. In some cases, the term “QoE measurement”, which typically refers to a measurement or data collection performed for the purpose of determining a QoE metric, may also refer to a QoE measurement configuration.

The terms “service” and “application” are used interchangeably.

The terms “MCE” and “TCE” are used interchangeably or can be seen as examples of the more general term “QoE Collector Entity” (QoE CE).

The terms “app identifier”, “application identifier”, “app identity”, “application identity”, “app ID” and “application ID” are used interchangeably herein.

The terms “QoE measurement configuration container”, “QoE configuration container” and “QMC configuration file” are considered equivalent in this document.

The terms “application version identifier” and “version identifier” are used interchangeably herein.

The solution is mainly described in terms of 3GPP 5G/NR, but the solution is equally applicable in other communication systems, e.g. LTE.

To address the above-described problem, the proposed solution leverages the existing association between each app/application distributed e.g. via App Store (Apple's store for iOS apps) or Google Play (Google's store for Android apps) and an identifier which uniquely identifies the app/application. In particular, a method performed by a user equipment for supporting Quality of Experience, QoE, measurements may comprise determining whether a QoE measurement configuration is to be applied to an application session based on an identifier relating to an application running the application session. Such an identifier can be used as distinguisher, or filter criterion, determining whether a certain QoE measurement configuration should be applied to a started application session. This identifier may be combined with the service type (and optionally also the S-NSSAI), so that QoE measurements in accordance with a certain QoE measurement configuration are performed on an application session only if all the distinguishers/filter criteria associated with the QoE measurement configuration (e.g. service type, app identifier and/or S-NSSAI) match those associated with the application running the session. For example, the determining may be further based on a service type. This mechanism thus enables multiple QoE measurement configurations for the same service type (in the same UE), where the application's associated identifier (e.g. app identifier or application identifier)—possibly in combination with the S-NSSAI and/or any other distinguisher/filter criterion—determines which (if any) of the QoE measurement configurations associated with the application's service type should be applied to a session of the application.

Thus, at least one QoE measurement corresponding to the QoE measurement configuration may be applied to the application session if a distinguisher and/or a filter criterion associated with the QoE measurement configuration match a distinguisher and/or a filter criterion corresponding to at least one of the identifier, a service type and S-NSSAI. If it is determined that a QoE measurement configuration should be applied to an application session, the method may comprise performing at least one QoE measurement corresponding to the QoE measurement configuration.

An identifier, app identifier, or application identifier, is a URL or a part of a URL. The URL is typically a combination of a part assigned by the store's software and a part assigned by the app developer/vendor. Some examples:

“https://play.google.com/store/apps/details?id=com.company.appname” (where the app ID would be “com.company.appname”).

“https://itunes.apple.com/us/app/urbanspoon/id284708449” (where the app ID would be what comes directly after “id”, i.e. “284708449”).

“https://itunes.apple.com/us/app/hotel-tonight-last-minute/id407690035?mt=8” (where the app ID would be “407690035”).

“1A234H7ABC.com.domainname.applicationname” (where “1A234H7ABC” is a “Team ID” generated by Apple and “com.domainname.applicationname” is a “Bundle ID” search string provided by the developer).

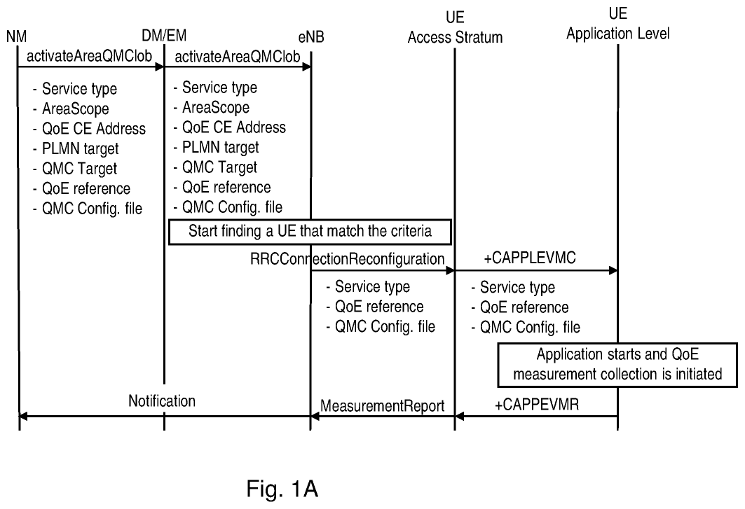

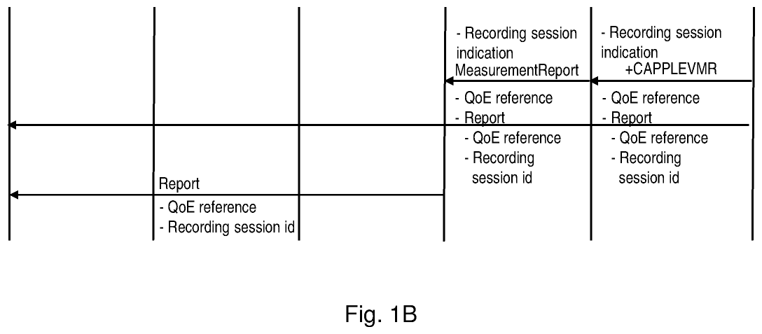

The application identifier(s) to be used as distinguisher/filter criterion for application of QoE measurement configuration(s) may be conveyed in various ways, e.g. inside or together with (but outside) the QoE measurement configuration container, over the involved signaling interfaces. The various signaling options may also include that the application identifier(s) may originate in different nodes, meaning that there are different options for which node that selects the application identifier(s) and includes it(them) in the signaling. It is even possible that one node selects one or more application identifier(s), and includes them in the signaling, and one or more other (subsequent) node(s) downstream in the signaling selects one or more additional application identifier(s) and includes it(them) in the signaling and/or removes previously included application identifier(s) from the signaling. As one example (referring to FIG. 1), the NM can select the application identifier(s) and include it(them) in the signaling message sent to the DM/EM. Other examples include that the DM/EM or the RAN (e.g. a gNB or an eNB) selects the application identifier(s) and includes it(them) in the signaling. Yet another example may be that the NM selects a first set of application identifier(s) and includes it(them) in the signaling message sent to the DM/EM, which forwards them to the RAN (gNB or eNB) and the RAN (gNB or eNB) selects and adds a second set of application identifier(s) and includes it(them) in the signaling message sent to the UE. In this last example, one possibility is that the NM includes the first set of application identifier(s) in the QMC configuration file, whereas the RAN (gNB or eNB) includes the second set of application identifier(s) in the signaling message to the UE outside the QMC configuration file (i.e. as a parameter, or parameters, separate from the QMC configuration file. In this case, as one embodiment, the first set of application identifier(s) may be part of a configuration for measurement and collection (and reporting) of “regular” QoE metrics (i.e. “regular”/legacy QoE measurement configuration), whereas the second set of application identifier(s) may be part of a configuration for measurement and collection (and reporting) of RAN Visible QoE metrics (i.e. RVQoE configuration).

The application identifier(s) may not only be included in the QoE measurement configuration signaling, but optionally also in the signaling related to QoE measurement reporting, as well as in the signaling conveying notifications of start/stop of application sessions. As one option, the application identifier of the application whose session QoE measurement has been performed on (and for which collected QoE data has been stored and used to prepare a QoE measurement report) may be signaled back from the UE to the network when the result of the QoE measurement, e.g. the collected QoE data, is reported (using a QoE measurement report). The application identifier may then be signaled in various ways over the involved signaling interfaces, e.g. inside or together with (but outside) the QoE measurement report container.

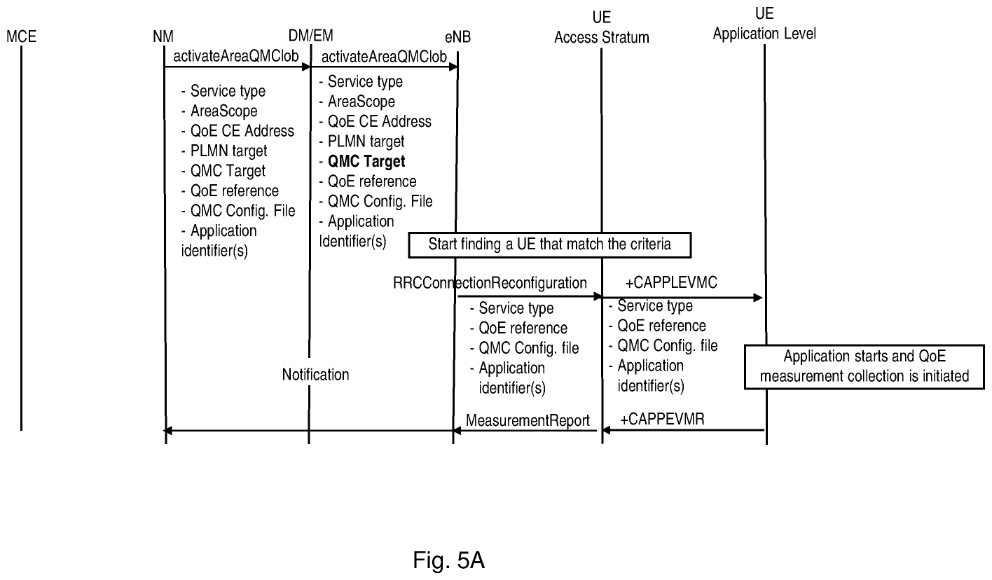

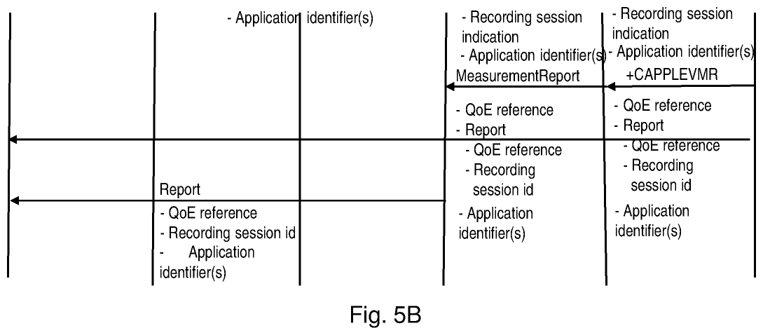

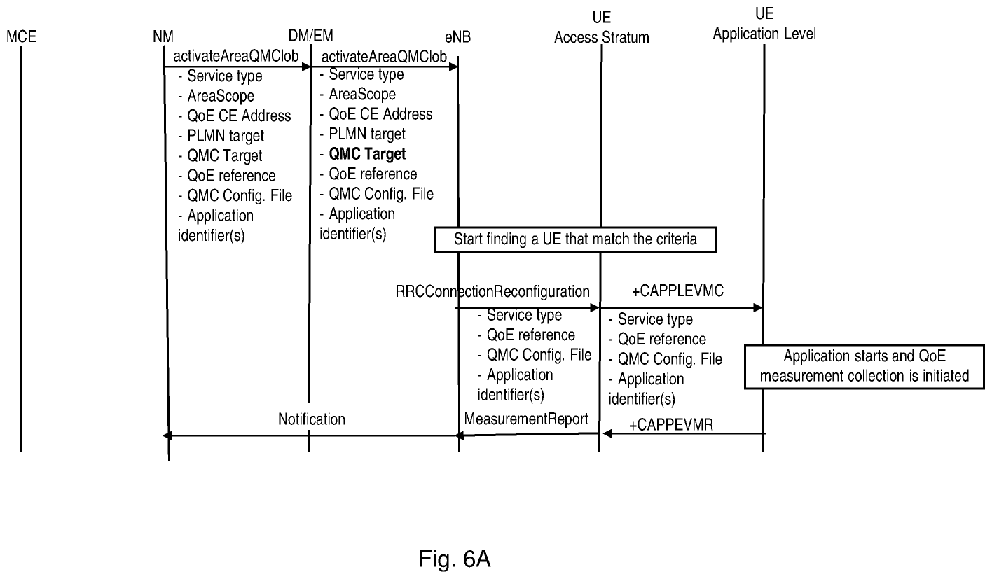

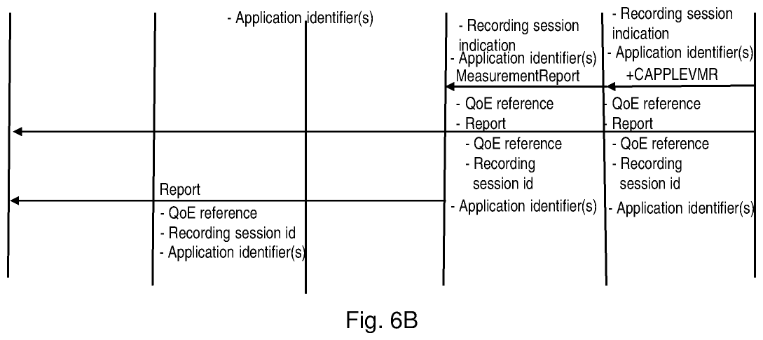

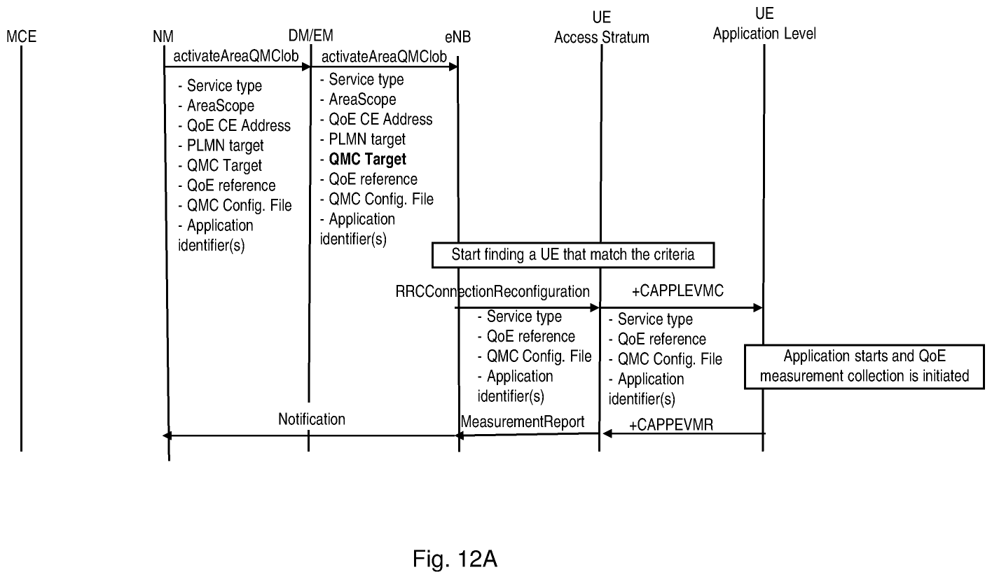

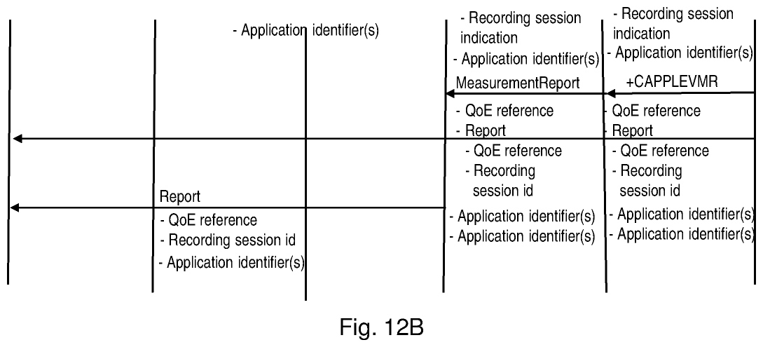

FIG. 5—FIG. 12 illustrate a number of examples of how the application identifier(s) (shown in red in the figures) may be included in the relevant signaling, based on the signaling diagram in FIG. 1.

FIG. 1 is a signalling diagram showing an example of how application identifier(s) can be incorporated in the signaling involved in QoE measurement configuration and QoE measurement reporting. (Based on the signaling diagram in Error! Reference source not found.)

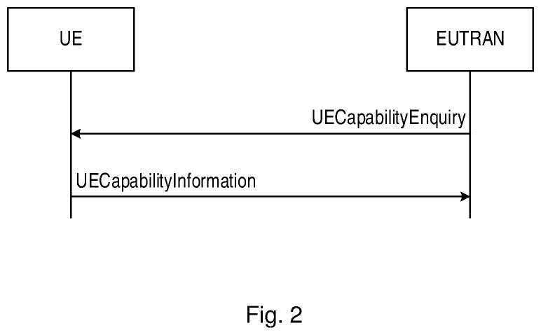

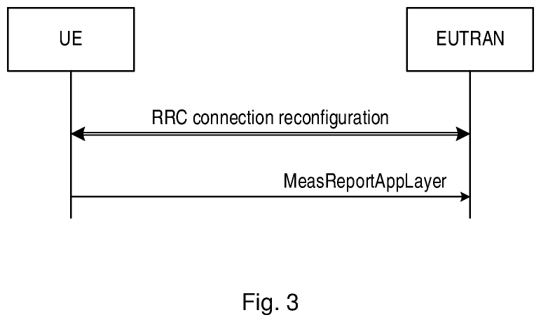

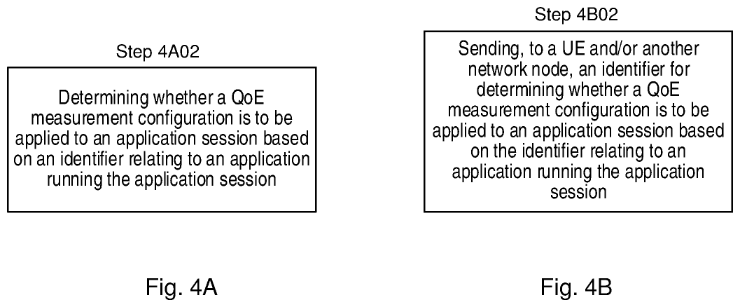

FIG. 2 is a signalling diagram showing an example of how application identifier(s) can be incorporated in the signaling involved in QoE measurement configuration and QoE measurement reporting. (Based on the signaling diagram in Error! Reference source not found.)

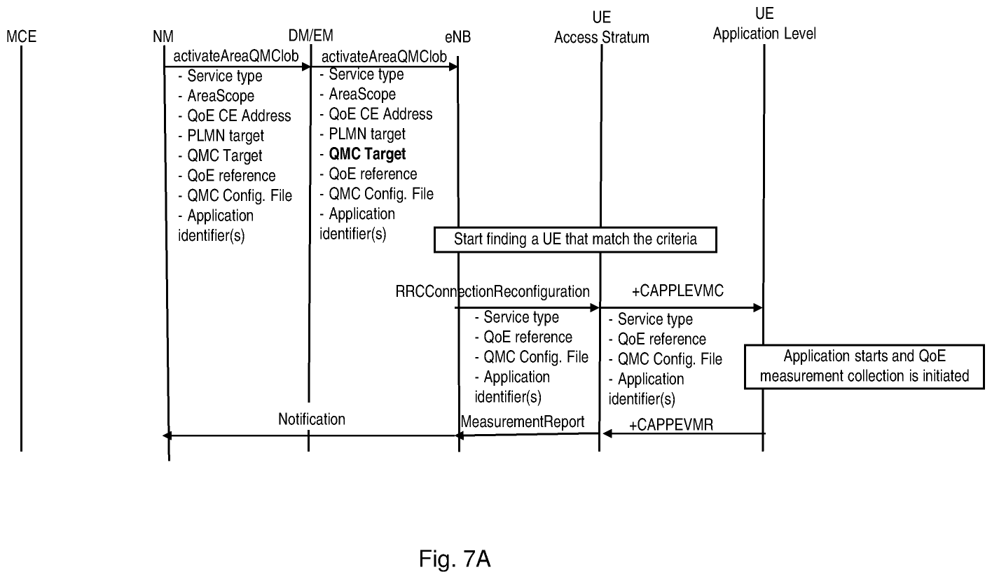

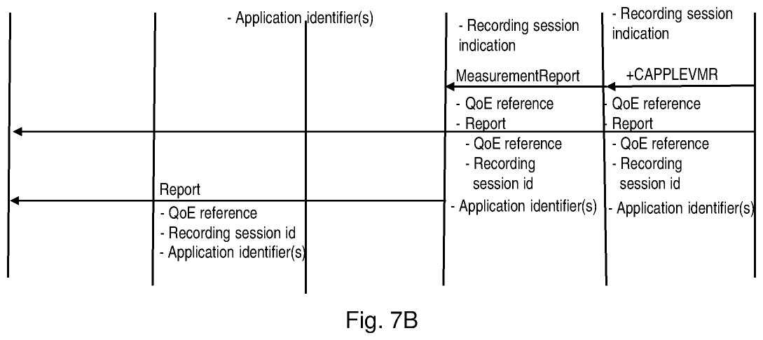

FIG. 7 is a signalling diagram showing an example of how application identifier(s) can be incorporated in the signaling involved in QoE measurement configuration and QoE measurement reporting. (Based on the signaling diagram in FIG. 1.)

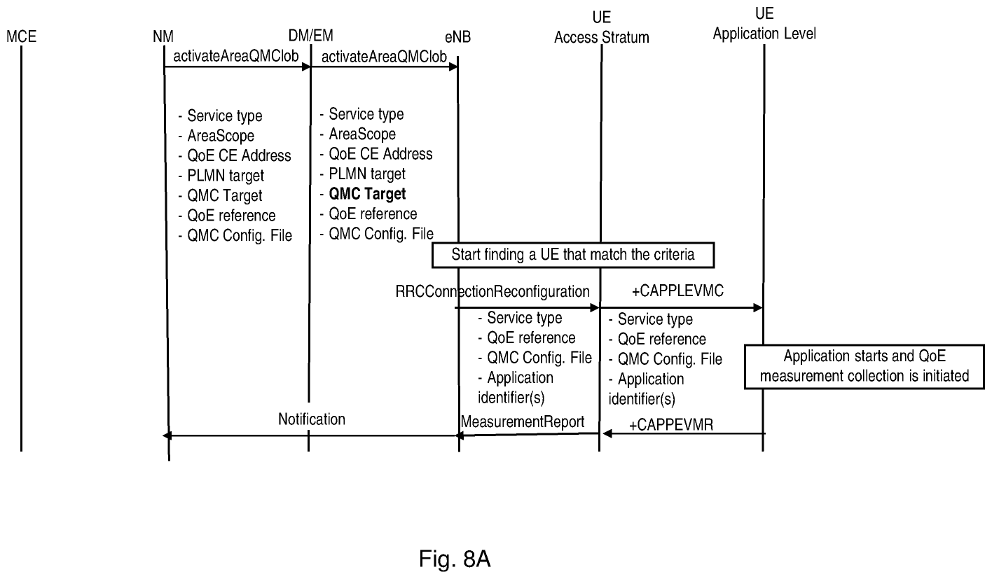

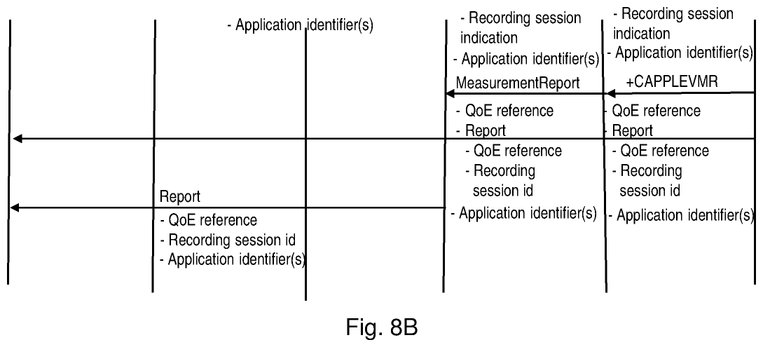

FIG. 8 is a signalling diagram showing an example of how application identifier(s) can be incorporated in the signaling involved in QoE measurement configuration and QoE measurement reporting. (Based on the signaling diagram in FIG. 1.)

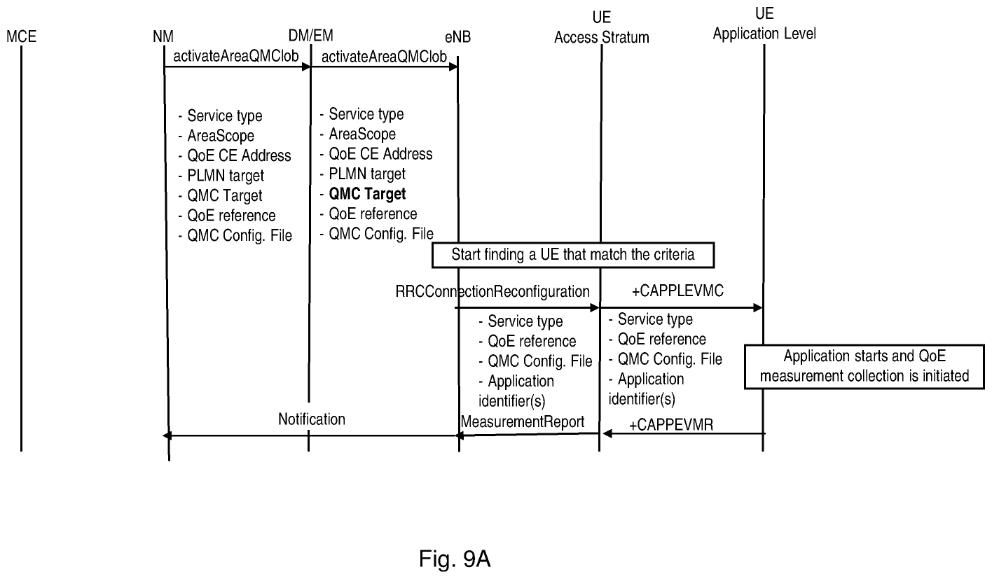

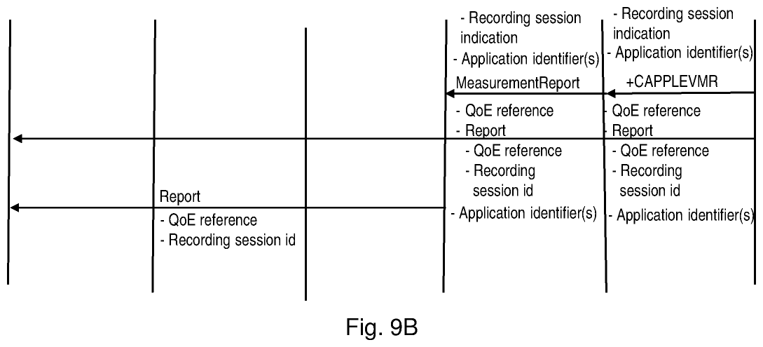

FIG. 9 is a signalling diagram showing an example of how application identifier(s) can be incorporated in the signaling involved in QoE measurement configuration and QoE measurement reporting. (Based on the signaling diagram in FIG. 1.)

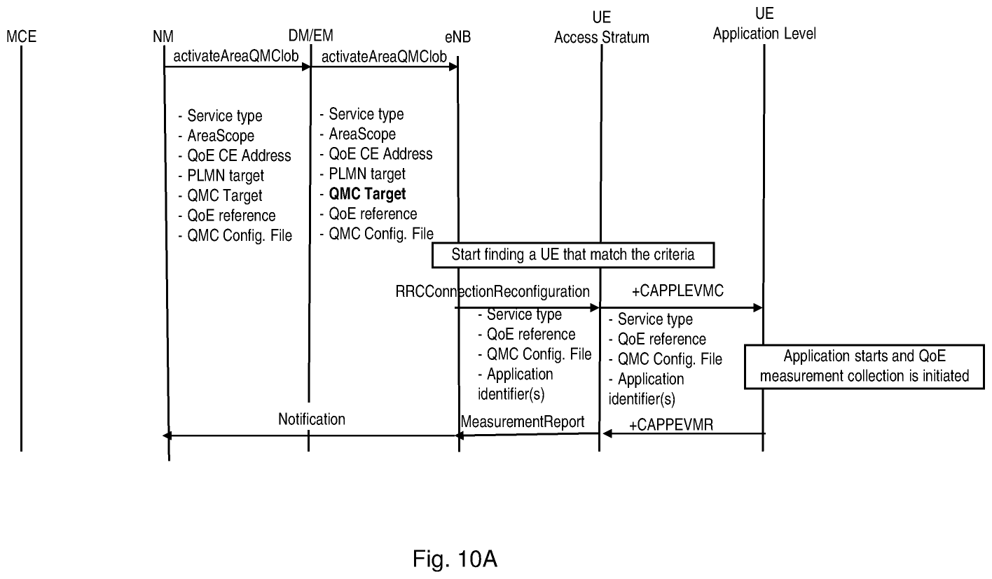

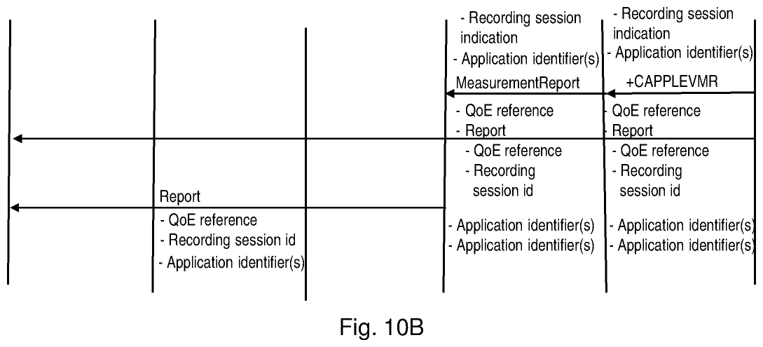

FIG. 10 is a signalling diagram showing an example of how application identifier(s) can be incorporated in the signaling involved in QoE measurement configuration and QoE measurement reporting. (Based on the signaling diagram in FIG. 1.)

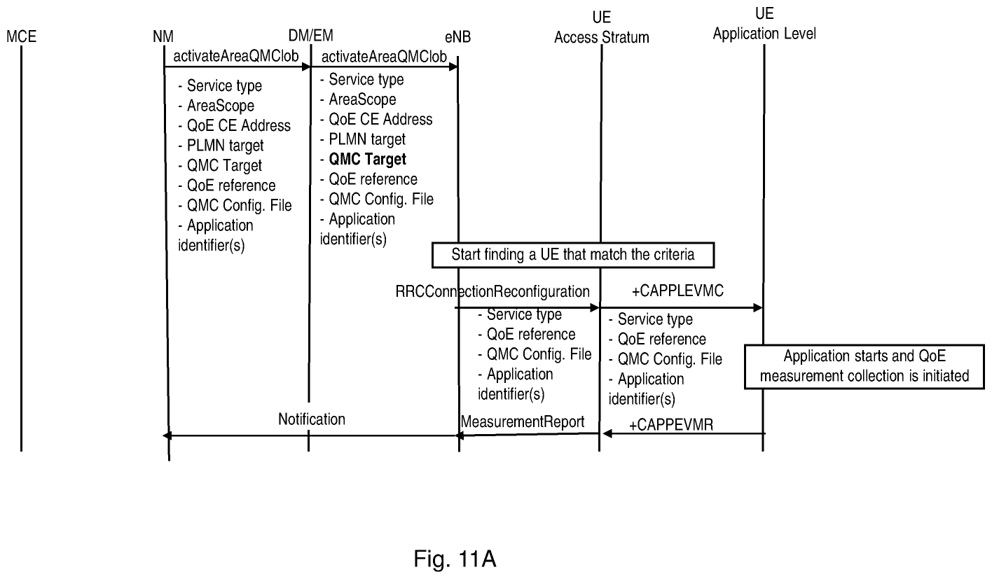

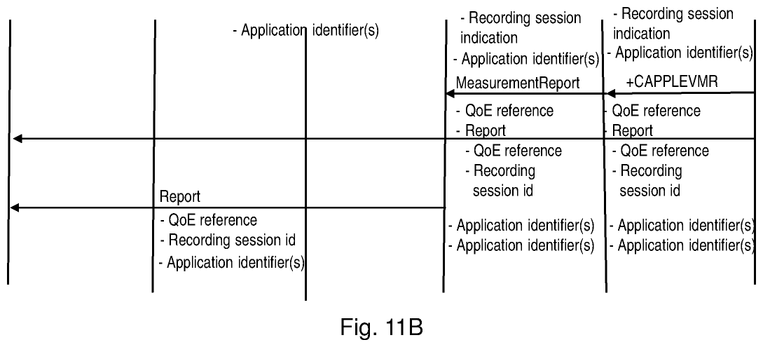

FIG. 11 is a signalling diagram showing an example of how application identifier(s) can be incorporated in the signaling involved in QoE measurement configuration and QoE measurement reporting. (Based on the signaling diagram in FIG. 1.)

FIG. 12 is a signalling diagram showing an example of how application identifier(s) can be incorporated in the signaling involved in QoE measurement configuration and QoE measurement reporting. (Based on the signaling diagram in FIG. 1.)

In an alternative solution, the application identifier is mapped to an RRC identifier, e.g. measConfigAppLayerId, The RRC identifier is sent to the UE together with the application identifier, e.g. upon configuration of the QoE measurement. When the UE sends a QoE report to the RAN node, the RRC identifier is attached together with the QoE report. The RAN node maps back the RRC identifier to the application identifier and the application identifier is forwarded to OAM/MCE/TCE together with the report. The mapping of the application identifier and RRC identifier may be forwarded between RAN nodes at e.g. handover, context fetch at connection re-establishment, resume etc. In this option, the application identifier may only need to be sent once to the UE and in subsequent messaging the RRC identifier may be used to identify the application (e.g. used as the identifier).

In some embodiments, the application identifier may be used as a distinguisher/filter criterion for RAN Visible QoE (RVQoE) measurement configurations, in which case the indication of the application identifier(s) for which a RVQoE measurement configuration is valid (provided that any other distinguisher/filter criterion is also matched/fulfilled) may originate in the RAN and may be conveyed to the UE as a part of, or together with (but not a part of), configuration data for RVQoE measurements and reporting.

In some embodiments, which may be combined with any of the previously described embodiments, a UE may indicate the application identifier(s) of relevant installed applications by means of capability signaling and/or on specific request from the network, or by means of newly defined signaling. This may help the network to select suitable UEs to be configured for QoE reporting. In particular, it may help the RAN to select suitable UEs for management based QoE configuration, or configuration for RVQoE, where application identifier(s) are used as distinguisher(s)/filter criterion/criteria. The information about the application identifier(s) sent as a part of UE capability signaling may also include information about the version of the application and/or the user subscription level (as explained below). In one embodiment, the UE may use capability signaling or newly defined signaling to update the information about currently installed applications (e.g., in the form of application identifiers (e.g. pertaining to newly installed application(s)), versions and user subscription level of the currently installed applications). This may happen e.g., when a new application is installed at the UE, when an existing application is updated or uninstalled etc.

Note that any identifier that uniquely identifies an application in a similar way as the app/application identifiers provided via App Store and Google Play may serve the purpose of application identifiers in the above-described solution embodiments.

In a possible use case scenario, an operator may be interested in rolling out a second (updated) version of an app/application and comparing its performance(s) with the first (preceding) version, where the performance(s) of the first version of the application is(are) assessed by means of QoE measurements associated with the first version of the app/application), and the performance(s) of the second version of the app/application is(are) assessed by means of QoE measurements associated with the second version of the app/application).

In this case, the app/application identifier can comprise or be complemented by an identifier identifying the application version (version identifier) for which QoE measurements are configured, collected, and reported. This version identifier can be used as part of the distinguisher/filter criterion and/or may be included in the QoE report and/or may be transmitted together with (outside) the QoE report to the MCE (or TCE or other receiving entity).

The entity receiving QoE measurements (e.g. an MCE or TCE, or another entity, such as a Core Network entity or an SMO entity) can perform a comparative analysis of the two app/application versions. The comparison can also involve correlation with other inputs in addition to QoE measurements, such as radio related measurements (e.g. RSRP levels, RSRQ levels, etc.) and/or radio related information (e.g. which RAT is in use, if MR-DC is used or not, number of carriers, etc.) and/or timestamps and/or geographical data collected by the UE or collected by a network node (such as a RAN node, a CN node, a positioning node or positioning function—such as a Location Management Function (LMF) or a Location Retrieval Function (LRF)—or another node/server such as a Gateway Mobile Location Centre (GMLC), an Evolved Serving Mobile Location Centre (E-SMLC)) and associated with the UE, where the correlated other inputs are collected in the time period during which the correlated application session is running and its associated QoE measurement is performed.

As a non-limiting example, a version identifier can be a string (e.g. “1.2.2”, or “1x02n”, or “2.2A”), a number, an enumerated, a URI, a URL.

In another (similar) scenario, an operator may be interested in rolling out a new app/application, in which case an identifier of an application version (e.g. a beta version) can be used as part of or together with an app/application identifier to allow for easier analysis of the QoE reports (and possible later correlation).

One or more of the following options are possible for an application version identifier:
An application version identifier may be an integral part of an app/application identifier (e.g. the version identifier is implicitly indicated by app/application identifier),
An application version identifier may be included within a regular QoE configuration (i.e. a QoE configuration not interpretable by a RAN node, e.g. a QMC configuration XML file),
An application version identifier may be included in the same message as a regular QoE configuration (but outside the QoE configuration), optionally in the same parameter structure, such as the OtherConfig IE and/or the measConfigAppLayer IE.
An application version identifier may be included within a RAN Visible QoE configuration (i.e. a QoE configuration interpretable and possibly created by a RAN node),
An application version identifier may be included in the same message as a RAN Visible QoE configuration (but outside of, i.e. not an integral part of, the RAN Visible QoE configuration), optionally in the same parameter structure, such as the OtherConfig IE.
An application version identifier may be included within a regular QoE report (i.e. a QoE report not interpretable by a RAN node, e.g. an XML file containing QoE measurement data),
An application version identifier may be included in the same message as a regular QoE report, e.g. a MeasReportAppLayer message (but outside of, i.e. not an integral part of, the QoE report), optionally within the same parameter structure, such as the MeasReportAppLayer-r15-IEs IE, but still outside the XML file constituting the regular QoE report, e.g. outside the measReportAppLayerContainer IE. An application version identifier may be included within a RAN Visible QoE report (i.e. a QoE report interpretable by a RAN node),
An application version identifier may be included in the same message as a RAN Visible QoE report, e.g. a MeasReportAppLayer message (but outside of, i.e. not an integral part of, the RAN Visible QoE report), optionally within the same parameter structure.
An application version identifier may be sent from an OAM node, or an SMO node or a CN node to a RAN node together with or as part of a regular QoE configuration,
An application version identifier may be sent from an OAM node, or an SMO node or a CN node to a RAN node together with or as part of a RAN Visible QoE configuration,
An application version identifier may be sent from a RAN node to a UE AS together with or as part of a regular QoE configuration (e.g. in an RRCReconfiguration message, an RRCResume message, an RRCReestablishment message),
An application version identifier may be sent from a RAN node to a UE AS together with or as part of a RAN Visible QoE configuration,
An application version identifier may be sent from a UE AS to a UE Application Layer together with or as part of an AT command (e.g. +CAPPLEVMC) comprising a regular QoE measurement configuration.
An application version identifier may be sent from a UE AS to a UE Application Layer together with or as part of an AT command (e.g. +CAPPLEVMC) comprising a RAN Visible QoE configuration.
An application version identifier may be sent from a UE Application Layer to a UE AS together with or as part of an AT command (e.g. +CAPPLEVMR) comprising a QoE measurement report.
An application version identifier may be sent from a UE AS to a RAN node together with or as part of one or more of: a QoE report, a RAN Visible QoE report, a message or information indicating Session Start or Session Stop/End, and/or a (RRM) measurement report.
An application version identifier may be sent from a UE AS to a RAN node together with or as part of: an RRC message (e.g. an RRCReconfigurationComplete message, an RRCResumeComplete message, an RRCReestablishment message, a MeasReportAppLayer message, a MeasurementReport message).
An application version identifier may be sent from a UE AS to a RAN node together with or as part of UE capability signaling. For instance, as previously described for application identifiers of applications installed in a UE, a UE may signal the application version identifier(s) of applications installed in the UE to the network in capability signaling, on request from the network, or using new signaling, wherein each application version identifier may be associated with an application identifier (pertaining to the same application) which is also signaled to the network.
An application version identifier may be sent from a RAN node to an MCE/TCE or an NM or DM or EM or an EMS together with or as part of a Notification message or a Report message.
An application version identifier may be mapped back from a RAN specific identifier received together with a report from the UE and further sent from the RAN node to an MCE/TCE.
An application version identifier may be sent from one RAN node to another RAN node together with the mapping towards the RRC identifier at e.g. handover, re-establishment, resume etc.

In one embodiment, in addition to the application identifier and application version identifier, the QoE measurement configuration may contain, or may be sent together with, information of user subscription level (i.e., subscription level of the user, for example a YouTube Premium user) for which the measurements are to be executed, for example “Basic user” or “Premium user”. In that sense, all options listed above for an application version identifier and all the embodiments herein referring to the application identifier, may equally apply to the identifier of the user subscription level. In a related embodiment, the UE includes in, or sends together with, the QoE report (regular/legacy QoE report and/or RAN Visible QoE report), together with the application identifier and application version identifier, an indication of the application user subscription level, e.g. a user subscription level identifier. In one embodiment, the indication of the application user subscription level is a part of the application identifier. In another embodiment, it is a separate information element.

In a related embodiment, the user subscription level can be implicitly derived (by the RAN or OAM) from the properties of the network slice(s) used for delivering the application data to the application/user (and for delivering data from the application/user).

One or more aspects pertaining to QoE measurements for an app/application (e.g. configuration, collection, reporting, storage, correlation, distribution) may be subject to user consent. In this case, in one embodiment, which may be combined with any of the previous embodiments, a user may indicate or revoke user consent for one or more aspects pertaining to QoE measurements for an app/application (e.g. to configure, collect, report, store, correlate, distribute QoE measurements for one or more app/application(s)), and wherein an application version identifier of an app/application may be relevant or not (e.g. the user consent may apply to a specific version of an application or to all versions of the same application, i.e. applications with the same application identifier but different application version identifiers).

In one embodiment, one or more indications pertaining to user consent for QoE measurements for an app/application are inherited from the user consent applicable for MDT measurements. In this case, if a user has granted or revoked consent for MDT measurements, the same applies to QoE measurements, e.g. for an app/application (identified by an application identifier), for an application version, for set of apps/applications (identified by a set of application identifiers), for a set of application versions (of the same application), a set of application versions for each of a set of applications, or for all QoE measurements.

In another embodiment, one or more indications pertaining to user consent for QoE measurements for an app/application, or an application version, are obtained separately (i.e. independently) from user consent applicable for MDT measurements.

In one embodiment, one or more validity criteria can be associated with user consent, such as a time period (e.g. data can be collected only for a week, data can be store for a maximum of one year), be applicable to all versions of the application or only to a specific version of the application, a radio access technology (e.g. only QoE reports collected when the UE is served by NR are relevant), geographical information (e.g. QoE measurements may only be performed within a certain geographical area or only outside a certain geographical area, or only QoE reports collected together with positioning data are relevant, or only QoE measurements collected for non-roaming users are relevant (or—vice versa—only roaming users are considered)).

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example illustrated in FIG. 13, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, a content source and analytics node, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the ULE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs). The processing circuitry 1402 may be operable to provide, either alone or in conjunction with other UE 1400 components, such as the memory 1410, UE 1400 functionality. For example, the processing circuitry 1402 may be configured to cause the UE 1402 to perform the methods as described with reference to FIG. 4A.

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In some embodiments, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes processing circuitry 1502, a memory 1504, a communication interface 1506, and a power source 1508, and/or any other component, or any combination thereof. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, network node 1500 functionality. For example, the processing circuitry 1502 may be configured to cause the network node to perform the methods as described with reference to FIG. 4B.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

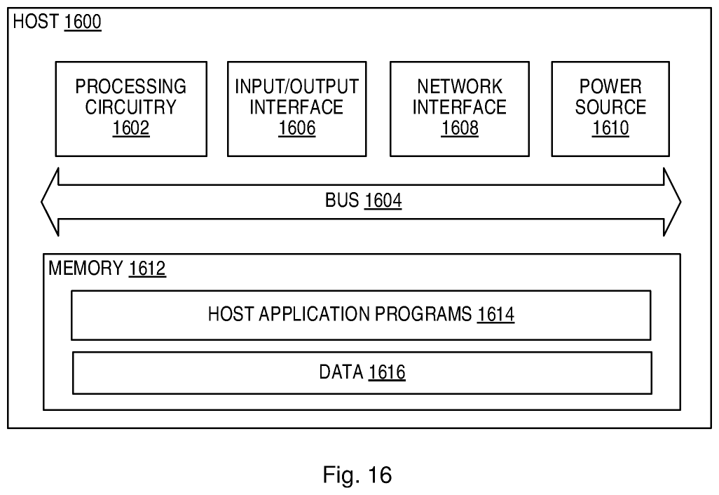

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

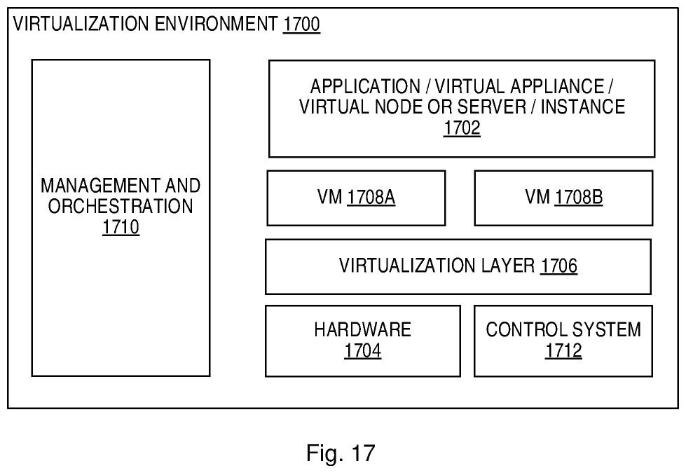

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

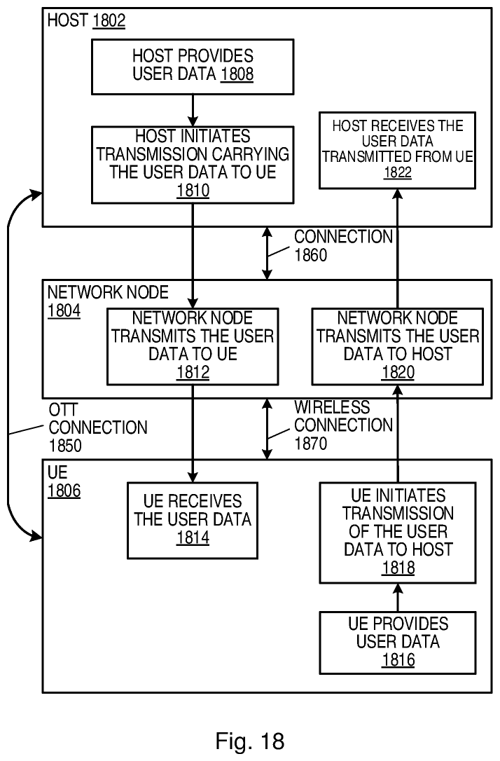

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may provide benefits such as allowing the network/operator to perform more fine-granular analysis of QoE related information, e.g. to determine if QoE related problems are more associated with certain application implementations than with others.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following numbered embodiments provide additional information on the disclosure.
1. A method performed by a user equipment for supporting Quality of Experience, QoE, measurements, the method comprising:
   determining whether a QoE measurement configuration is to be applied to an application session based on an identifier relating to an application running the application session.
2. The method of embodiment 1, wherein the determining is further based on a service type.
3. The method of any preceding embodiment, wherein the determining is further based on Single Network Slice Selection Assistance Information, S-NSSAI.
4. The method of any preceding embodiment, wherein at least one of the identifier, a service type, and an S-NSSAI is usable as a distinguisher and/or a filter criterion to determine whether a QoE measurement configuration is to be applied to the application session.
5. The method of any preceding embodiment, wherein at least one QoE measurement corresponding to the QoE measurement configuration is applied to the application session if a distinguisher and/or a filter criterion associated with the QoE measurement configuration match a distinguisher and/or a filter criterion corresponding to at least one of the identifier, a service type and S-NSSAJ.
6. The method of any preceding embodiment, wherein if it is determined that a QoE measurement configuration should be applied to an application session, performing at least one QoE measurement corresponding to the QoE measurement configuration.
7. The method of embodiment 6, wherein the method further comprises sending a QoE report of the at least one QoE measurement to a network node.
8. The method of any preceding embodiment, wherein the method further comprises sending the identifier to a network node.
9. The method of embodiment 8, wherein the method further comprises sending the identifier in a QoE report and/or outside the QoE report.
10. The method of any of embodiment 7 to 9, wherein the QoE report further comprises at least one of: the identifier, an application identifier, an application version identifier, an indication of the application user subscription level.
11. The method of embodiment 10, wherein the indication of the application user subscription level is part of the identifier or is a separate information element.
12. The method of any preceding embodiment, the method further comprising receiving the identifier from a network node.
13. The method of any preceding embodiment, wherein the method further comprises sending a QoE report of the at least one QoE measurement to a network node.
14. The method of any preceding embodiment, wherein the identifier relates to at least one of: the application, a version of the application, an application implementation.
15. The method of any preceding embodiment, wherein the identifier comprises at least one of: a URL, a part of a URL, a URI, a string, a number, an enumerated.
16. The method of any preceding embodiment, wherein where the identifier is at least one of: comprises an application version identifier, the application version identifier is an integral part of an application identifier, comprised in a regular QoE configuration, comprised in the same message as a regular QoE configuration and optionally comprised in the same parameter structure; comprised within a RAN Visible QoE configuration; comprised in the same message as a RAN Visible QoE configuration and optionally in the same parameter structure; comprised within a regular QoE report; comprised in the same message as a regular QoE report and optionally within the same parameter structure and outside the XML file constituting the regular QoE report; comprised within a RAN Visible QoE report; comprised in the same message as a RAN Visible QoE report and optionally within the same parameter structure; received from a network node together with or as part of a regular QoE configuration; received from a network node together with or as part of a RAN Visible QoE configuration; sent from a UE AS to a UE Application Layer together with or as part of an AT command comprising a regular QoE measurement configuration; sent from a UE AS to a UE Application Layer together with or as part of an AT command comprising a RAN Visible QoE configuration; sent from a UE Application Layer to a UE AS together with or as part of an AT command comprising a QoE measurement report; sent from a UE AS to a RAN node together with or as part of one or more of: a QoE report, a RAN Visible QoE report, a message or information indicating Session Start or Session Stop/End, and/or a (RRM) measurement report; sent from a UE AS to a RAN node together with or as part of: an RRC message; sent from a UE AS to a RAN node together with or as part of UE capability signaling.
17. The method of any preceding embodiment, wherein the method further comprises sending an indication of an identifier relating to an application installed at the UE to a network node.
18. The method of embodiment 17, wherein the indication is sent using capability signaling and/or on request from the network in which the UE is comprised, and/or using a separate signaling.
19. The method of embodiment 17 to 18, wherein the method further comprises sending the indication when at least one of: a new application is installed at the UE; an existing application is updated; an existing application is uninstalled.
20. The method of embodiment 17 to 19, wherein the indication comprises information on at least one of: an application, a version of an application, a user subscription level.
21. The method of any preceding embodiment, wherein the determining is further based on a user subscription level.
22. The method of embodiment 21, wherein the user subscription level is comprised in, or received together with, the QoE measurement configuration.
23. The method of any preceding embodiment, wherein the determining is further based on an indication pertaining to user consent for one or more aspects relating to QoE measurements for at least one of: an application, a version of an application, a set of applications, a set of application versions, a set of application versions for each of a set of applications.
24. The method of embodiment 23, wherein an indication pertaining to user consent for MDT measurements is used as the indication pertaining to user consent for one or more aspects relating to QoE measurements, or wherein the indication pertaining to user consent is obtained.
25. The method of embodiment 23 or 24, wherein the indication pertaining to user consent comprises at least one of: a time period, an application, a version of an application, radio access technology, geographical information.
26. The method of any preceding embodiment, further comprising:
   providing user data; and
   forwarding the user data to a host via the transmission to the network node.
27. A method performed by a network node for supporting Quality of Experience, QoE, measurements, the method comprising:
   sending, to a UE and/or another network node, an identifier for determining whether a QoE measurement configuration is to be applied to an application session based on the identifier relating to an application running the application session.
28. The method of embodiment 27, the method further comprising receiving a QoE report of at least one QoE measurement.
29. The method of embodiment 27 or 28, wherein the QoE report further comprises at least one of: the identifier, an application identifier, an application version identifier, an indication of the application user subscription level.
30. The method of embodiment 27 to 29, wherein the method further comprises receiving an identifier.
31. The method of embodiment 27 to 30, wherein the identifier is at least one of: an application identifier, an application version identifier, an RRC identifier.
32. The method of embodiment 27 to 31, wherein the identifier relates to at least one of: the application; a version of the application; an application implementation.
33. The method of embodiment 27 to 32, wherein the identifier comprises at least one of: a URL, a part of a URL, a URI, a string, a number, an enumerated.
34. The method of embodiment 27 to 33, the method further comprising receiving an indication of an identifier relating to an application installed at the UE.
35. The method of embodiment 34, the method further comprising receiving the indication responsive to requesting the indication.
36. The method of embodiment 27 to 35, the method further comprising sending a user subscription level.
37. The method of embodiment 27 to 36, the method further comprising deriving a user subscription level from the properties of a network slice used for delivering application data to the application/user.
38. The method of embodiment 27 to 37, the method further comprising receiving an identifier from another network node and/or selecting an identifier.
39. The method of embodiment 38, the method further comprising sending at least one of the identifier received from another network node and/or the selected identifier.
40. The method of embodiment 27 to 39, the method further comprising receiving from another network node a first set of identifiers and selecting a second set of identifiers.
41. The method of embodiment 40, wherein one of the first set of identifiers and the second set of identifiers is part of a configuration for measurement and collection of regular QoE metrics, and the other of the first set of identifiers and the second set of identifiers is part of a configuration for measurement and collection of RAN Visible QoE metrics.
42. The method of embodiment 27 to 41, the method further comprising receiving at least two QoE measurements corresponding to two identifiers, and comparing the at least two QoE measurements.
43. The method of embodiment 42, wherein the comparison further comprises determining correlation of inputs relating to at least one of: radio related measurements, radio related information, timestamps, geographical data associated with the UE, and wherein the inputs are collected in a time period during which the corresponding application session is running and a QoE measurement is performed.
44. The method of embodiment 27 to 43, wherein at least one of: the identifier is comprised in QoE measurement configuration signaling; the identifier is comprised in signaling related to QoE measurement reporting; the identifier is comprised in signaling related to start/stop notifications of application sessions; the identifier is comprised as a part of, or together with, configuration data for RAN Visible QoE measurements and reporting.
45. The method of embodiment 27 to 44, wherein where the identifier is at least one of: an comprises an application version identifier, the application version identifier is an integral part of an application identifier, comprised in a regular QoE configuration, comprised in the same message as a regular QoE configuration and optionally comprised in the same parameter structure; comprised within a RAN Visible QoE configuration; comprised in the same message as a RAN Visible QoE configuration and optionally in the same parameter structure; comprised within a regular QoE report; comprised in the same message as a regular QoE report and optionally within the same parameter structure and outside the XML file constituting the regular QoE report; comprised within a RAN Visible QoE report; comprised in the same message as a RAN Visible QoE report, optionally within the same parameter structure; sent from an OAM node, or an SMO node or a CN node to a RAN node together with or as part of a regular QoE configuration; sent from an OAM node, or an SMO node or a CN node to a RAN node together with or as part of a RAN Visible QoE configuration; sent from a RAN node to a UE AS together with or as part of a regular QoE configuration; sent from a RAN node to a UE AS together with or as part of a RAN Visible QoE configuration; sent from a RAN node to an MCE/TCE or an NM or DM or EM or an EMS together with or as part of a Notification message or a Report message; mapped back from a RAN specific identifier received together with a report from the UE and further sent from the RAN node to an MCE/TCE; sent from one RAN node to another RAN node together with the mapping towards the RRC identifier.
46. The method of any of embodiments 27 to 45, further comprising:
   obtaining user data; and
   forwarding the user data to a host or a user equipment.
47. A user equipment for supporting Quality of Experience, QoE, measurements, comprising:
   processing circuitry configured to cause the user equipment to perform any of the steps of any of embodiments 1 to 26; and
   power supply circuitry configured to supply power to the processing circuitry.
48. A network node for supporting Quality of Experience, QoE, measurements, the network node comprising:
   processing circuitry configured to cause the network node to perform any of the steps of any of embodiments 27 to 46;
   power supply circuitry configured to supply power to the processing circuitry.
49. A user equipment (UE) for supporting Quality of Experience, QoE, measurements, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of embodiments 1 to 26;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
50. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of embodiments 1 to 26 to receive the user data from the host.
51. The host of embodiment 50, wherein the cellular network further includes a network node configured to communicate with the UE to transmit the user data to the UE from the host.
52. The host of any of embodiments 50 and 51, wherein:
   the processing circuitry of the host is configured to execute a host application, thereby providing the user data; and
   the host application is configured to interact with a client application executing on the UE, the client application being associated with the host application.
53. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of embodiments 1 to 26 to receive the user data from the host.
54. The method of embodiment 53, further comprising:
   at the host, executing a host application associated with a client application executing on the UE to receive the user data from the UE.
55. The method of embodiment 54, further comprising:
   at the host, transmitting input data to the client application executing on the UE, the input data being provided by executing the host application,
   wherein the user data is provided by the client application in response to the input data from the host application.
56. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of embodiments 1 to 26 to transmit the user data to the host.
57. The host of embodiment 56, wherein the cellular network further includes a network node configured to communicate with the UE to transmit the user data from the UE to the host.
58. The host of any of embodiments 56 and 57, wherein:
   the processing circuitry of the host is configured to execute a host application, thereby providing the user data; and
   the host application is configured to interact with a client application executing on the UE, the client application being associated with the host application.
59. A method implemented by a host configured to operate in a communication system that further includes a network node and a user equipment (UE), the method comprising:
   at the host, receiving user data transmitted to the host via the network node by the UE, wherein the UE performs any of the steps of any of embodiments 1 to 26 to transmit the user data to the host.
60. The method of embodiment 59, further comprising:
   at the host, executing a host application associated with a client application executing on the UE to receive the user data from the UE.
61. The method of embodiment 60, further comprising:
   at the host, transmitting input data to the client application executing on the UE, the input data being provided by executing the host application,
   wherein the user data is provided by the client application in response to the input data from the host application.
62. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of embodiments 27 to 46 to transmit the user data from the host to the UE.
63. The host of embodiment 62, wherein:
   the processing circuitry of the host is configured to execute a host application that provides the user data; and
   the UE comprises processing circuitry configured to execute a client application associated with the host application to receive the transmission of user data from the host.
64. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of embodiments 27 to 46 to transmit the user data from the host to the UE.
65. The method of embodiment 64, further comprising, at the network node, transmitting the user data provided by the host for the UE.
66. The method of any of embodiments 64 and 65, wherein the user data is provided at the host by executing a host application that interacts with a client application executing on the UE, the client application being associated with the host application.
67. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of embodiments 27 to 46 to transmit the user data from the host to the UE.
68. The communication system of embodiment 67, further comprising:
   the network node; and/or
   the user equipment.
69. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of embodiments 27 to 46 to receive the user data from a user equipment (UE) for the host.
70. The host of embodiment 69, wherein:
   the processing circuitry of the host is configured to execute a host application, thereby providing the user data; and
   the host application is configured to interact with a client application executing on the UE, the client application being associated with the host application.
71. The host of the any of embodiments 69 and 70, wherein the initiating receipt of the user data comprises requesting the user data.
72. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of embodiments 27 to 46 to receive the user data from the UE for the host.
73. The method of embodiment 72, further comprising at the network node, transmitting the received user data to the host.

1-38. (canceled)

39. A method performed by a user equipment for supporting Quality of Experience (QoE) measurements, the method comprising:
receiving an identifier for determining whether a QoE measurement configuration is to be applied to an application session based on an identifier relating to an application running the application session; and
determining whether a QoE measurement configuration is to be applied to an application session based on the identifier.

40. The method of claim 39, wherein the determining is further based on a service type.

41. The method of claim 39, wherein the determining is further based on Single Network Slice Selection Assistance Information (S-NSSAI).

42. The method of claim 39, wherein at least one of the identifier, a service type, and an S-NSSAI is usable as a distinguisher and/or a filter criterion to determine whether a QoE measurement configuration is to be applied to the application session.

43. The method of claim 39, wherein at least one QoE measurement corresponding to the QoE measurement configuration is applied to the application session if a distinguisher and/or a filter criterion associated with the QoE measurement configuration match a distinguisher and/or a filter criterion corresponding to at least one of the identifier, a service type and S-NSSAI.

44. The method of claim 39, wherein if it is determined that a QoE measurement configuration should be applied to an application session, performing at least one QoE measurement corresponding to the QoE measurement configuration, optionally wherein the method further comprises sending a QoE report of the at least one QoE measurement to a network node.

45. The method of claim 39, wherein the method further comprises sending the identifier to a network node, optionally wherein the method further comprises sending the identifier in a QoE report and/or outside the QoE report.

46. The method of claim 39, wherein at least one of the following applies to the identifier:
the identifier comprises an application version identifier, the application version identifier is an integral part of an application identifier, comprised in a regular QoE configuration and he identifier is comprised in the same message as a regular QoE configuration;
the identifier is comprised within a RAN Visible QoE configuration;
the identifier is comprised in the same message as a RAN Visible QoE configuration;
the identifier is comprised within a regular QoE report;
the identifier is comprised in the same message as a regular QoE report and within the same parameter structure and outside the XML file constituting the regular QoE report;
the identifier is comprised within a RAN Visible QoE report;
the identifier is comprised in the same message as a RAN Visible QoE report and within the same parameter structure;
the identifier is received from a network node together with or as part of a regular QoE configuration;
the identifier is received from a network node together with or as part of a RAN Visible QoE configuration; the identifier is sent from a UE AS to a UE Application Layer together with or as part of an AT command comprising a regular QoE measurement configuration;
the identifier is sent from a UE AS to a UE Application Layer together with or as part of an AT command comprising a RAN Visible QoE configuration;
the identifier is sent from a UE Application Layer to a UE AS together with or as part of an AT command comprising a QoE measurement report; the identifier is sent from a UE AS to a RAN node together with or as part of one or more of a QoE report, a RAN Visible QoE report, a message or information indicating Session Start or Session Stop/End, and/or a RRM measurement report;
the identifier is sent from a UE AS to a RAN node together with or as part of an RRC message; the identifier is sent from a UE AS to a RAN node together with or as part of UE capability signaling.

47. The method of claim 39, wherein the determining is further based on a user subscription level, optionally wherein the user subscription level is comprised in, or received together with, the QoE measurement configuration.

48. The method of claim 39, wherein the determining is further based on an indication pertaining to user consent for one or more aspects relating to QoE measurements for at least one of: an application, a version of an application, a set of applications, a set of application versions, a set of application versions for each of a set of applications.

49. A method performed by a network node for supporting Quality of Experience (QoE) measurements, the method comprising:
sending, to a UE and/or another network node, an identifier for determining whether a QoE measurement configuration is to be applied to an application session based on the identifier relating to an application running the application session.

50. The method of claim 49, the method further comprising receiving a QoE report of at least one QoE measurement.

51. The method of claim 49, wherein the QoE report further comprises at least one of: the identifier, an application identifier, an application version identifier, an indication of the application user subscription level.

52. The method of claim 49, wherein the method further comprises receiving an identifier, wherein the identifier is at least one of: an application identifier, an application version identifier, an RRC identifier, and/or wherein the identifier relates to at least one of: the application; a version of the application; an application implementation, and/or wherein the identifier comprises at least one of: a URL, a part of a URL, a URI, a string, a number, an enumerated.

53. The method of claim 49, the method further comprising receiving an indication of an identifier relating to an application installed at the UE, optionally wherein the method further comprises receiving the indication responsive to requesting the indication.

54. The method of claim 49, the method further comprising sending a user subscription level, and/or the method further comprising deriving a user subscription level from the properties of a network slice used for delivering application data to the application/user.

55. The method of claim 49, the method further comprising receiving an identifier from another network node and/or selecting an identifier, optionally wherein the method further comprises sending at least one of the identifier received from another network node and/or the selected identifier.

56. The method of claim 49, wherein at least one of the following applies to the identifier:
the identifier comprises an application version identifier, the application version identifier is an integral part of an application identifier, comprised in a regular QoE configuration and he identifier is comprised in the same message as a regular QoE configuration;
the identifier is comprised within a RAN Visible QoE configuration;
the identifier is comprised in the same message as a RAN Visible QoE configuration;
the identifier is comprised within a regular QoE report;
the identifier is comprised in the same message as a regular QoE report and within the same parameter structure and outside the XML file constituting the regular QoE report;
the identifier is comprised within a RAN Visible QoE report;
the identifier is comprised in the same message as a RAN Visible QoE report and within the same parameter structure;
the identifier is received from a network node together with or as part of a regular QoE configuration;
the identifier is received from a network node together with or as part of a RAN Visible QoE configuration; the identifier is sent from a UE AS to a UE Application Layer together with or as part of an AT command comprising a regular QoE measurement configuration;
the identifier is sent from a UE AS to a UE Application Layer together with or as part of an AT command comprising a RAN Visible QoE configuration;
the identifier is sent from a UE Application Layer to a UE AS together with or as part of an AT command comprising a QoE measurement report; the identifier is sent from a UE AS to a RAN node together with or as part of one or more of a QoE report, a RAN Visible QoE report, a message or information indicating Session Start or Session Stop/End, and/or a RRM measurement report;
the identifier is sent from a UE AS to a RAN node together with or as part of an RRC message; the identifier is sent from a UE AS to a RAN node together with or as part of UE capability signaling.

57. A user equipment for supporting Quality of Experience (QoE) measurements, comprising:
processing circuitry configured to cause the user equipment to determine whether a QoE measurement configuration is to be applied to an application session based on an identifier relating to an application running the application session; and
power supply circuitry configured to supply power to the processing circuitry.

58. A network node for supporting Quality of Experience (QoE) measurements, the network node comprising:
processing circuitry configured to cause the network node to send, to a UE and/or another network node, an identifier for determining whether a QoE measurement configuration is to be applied to an application session based on the identifier relating to an application running the application session;
power supply circuitry configured to supply power to the processing circuitry.
